(19) United States
(12) Patent Application Publication
(10) Pub. No.: US 2014/0089804 A1
(43) Pub. Date: Mar. 27, 2014

(54) INTERACTIVE CREATION OF A MOVIE

(71) Applicant: BURKIBERK LTD., TEL AVIV (IL)

(72) Inventors: Ofer GAZIT, Ganei Tikva (IL); Sharon Gazit, Herzliya (IL); Daled Dotan, Tel Aviv (IL)

(21) Appl. No.: 14/034,560

(22) Filed: Sep. 24, 2013

Related U.S. Application Data
(60) Provisional application No. 61/704,582, filed on Sep. 24, 2012.

(51) Int. Cl. G06F 3/0484

(52) U.S. Cl. CPC G06F 3/0484
USPC 715/723

(57) ABSTRACT

A system for creating an animated and/or non-animated movie includes a database and a movie editor. The database stores at least one script and at least one modifiable, animated and/or non-animated clip. The movie editor receives and stores user input with which to build an modifiable movie following one of the at least one script and formed of selected ones of the clips using the user input, enables the user to update any of the user input, plays the modifiable movie with the updated user input, and creates a playlist from the at least one script, the clips and at least one the user input. The system also includes a genre changer generating a new playlist for the modifiable movie by selecting clips from the database belonging to a new genre using the existing user input and to providing the modifiable movie in the new genre to the movie editor.

### CROSS-REFERENCE TO RELATED APPLICATIONS

This application claims priority from U.S. Provisional Patent Application 61/704,582, filed Sep. 24, 2012, which is hereby incorporated in its entirety by reference.

### FIELD OF THE INVENTION

The present invention relates to computer movie creation generally and to user interaction in particular.

### BACKGROUND OF THE INVENTION

The use of personalized presentations at social and professional events has become very popular, with hosts often creating both amateur and/or professional presentations of life events in order to entertain viewers. For example, for a wedding, the presentation may include a story line together with different media clips of the bride and groom leading up to their eventual meeting and falling in love. It will be appreciated that such presentations can include anything from simple slide shows of photographs to full length movies.

There exist many products on the market today for amateurs to create such home made presentations, from PowerPoint and Windows Movie Maker, both commercially available from Microsoft Inc. of Washington D.C., USA to more sophisticated programs, such as Animoto, commercially available from Animoto Inc., of California USA and Xtranormal, commercially available from Xtranormal Inc., of California USA.

### SUMMARY OF THE INVENTION

There is therefore provided, in accordance with a preferred embodiment of the present invention, a system for creating an animated and/or non-animated movie, where the system is implementable on a computing device. The system includes a database and a movie editor. The database stores at least one script and at least one modifiable, animated and/or non-animated clip. The movie editor receives and stores user input with which to build an modifiable movie following one of the at least one script and formed of selected ones of the clips using the user input, enables the user to update any of the user input, plays the modifiable movie with the updated user input, and creates a playlist from the at least one script, the clips and at least one the user input.

Additionally, in accordance with a preferred embodiment of the present invention, the movie editor includes a user interface, an interpreter, a coordinator and an applier. The user interface presents questions to and/or enables selections from a user according to a script and receives the user input and the interpreter interprets the script according to the user input. The coordinator retrieves and saves information in the database and the applier applies the user input as variables to update the selected clips.

Moreover, in accordance with a preferred embodiment of the present invention, selected clips include objects having properties which are at least parametrizable or/and personalizable with user input and is at least one of: a selection from a list, texts, images, sounds, colors, skin tone, video, and answers to questions.

Further, in accordance with a preferred embodiment of the present invention, the script is a set of rules of how to manage the clips and user input to produce a movie. The system includes a renderer which will render the movie according to a playlist.

Still further, in accordance with a preferred embodiment of the present invention, the clips include at least two layers of objects and the movie editor displays at least two layers at least partially overlapped. In addition, it could play at least two clips on a divided screen when instructed by the playlist to do so.

Additionally, in accordance with a preferred embodiment of the present invention, the clips are defined as belonging to a genre. The system includes a genre changer to generate a new playlist for a modifiable movie by selecting clips from a database belonging to a new genre using existing user input and to provide a modifiable movie in a new genre to the movie editor.

There is also provided, in accordance with a preferred embodiment of the present invention, a system for creating an animated and/or non-animated movie, which is implementable on a computing device. The system includes a database of parametrized clips and a movie editor to select clips according to the user input and to provide parameters for at least one of the clips according to user input.

In addition, in accordance with a preferred embodiment of the present invention, there is provided a method for personalizing an animated or/and non-animated movie, which is implementable on a computing device. The method includes having at least one animated or/and non-animated clip, each clip having at least one variable property. The method receives the user input to personalize at least one of at least one variable property and plays at least one of an animated or/and non-animated clips with user input for the variable property.

The present invention includes the methods performed by the system and the systems created by the methods.

### BRIEF DESCRIPTION OF THE DRAWINGS

The subject matter regarded as the invention is particularly pointed out and distinctly claimed in the concluding portion of the specification. The invention, however, both as to the organization and method of operation, together with objects, features, and advantages thereof, may best be understood by reference to the following detailed description when read with the accompanying drawings in which:

FIG. 1A is a schematic illustration of a user view of a simple generic script;

FIG. 1B is a schematic illustration of a system view of the simple generic script of FIG. 1A;

FIG. 1C is a schematic illustration of a tree representation of a generic script;

FIGS. 2A and 2B are two parts of a schematic illustration of a program script, constructed and operative in accordance with the present invention;

FIG. 3 is a schematic illustration of a time line for a program script similar to that represented in FIGS. 2A and 2B;

FIG. 4 is a schematic illustration of a system for generating and creating an animated video, constructed and operative in accordance with the present invention;

FIG. 5 is a schematic illustration of a cartoon character with a photograph of a human head superimposed on it; and

FIG. 6 is a schematic illustration of scene creation through layering,

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that a way of creating and personalizing a presentation is to create a personal story through animated or non-animated video. Applicants have further realized that it is possible to create such a movie by asking a user a variety of questions and concatenating together a variety of clips according to the answers received. These clips may be pre-prepared or user created and may be animated or non-animated clips as well as sound, images, text etc. It will be appreciated that such resources may be static, such as standard video clips and audio files, or may be dynamic and therefore modifiable by external properties (i.e. parametrizable with user input), such as text fields that may be changed, sound that may be added or components that may be edited.

It will also be appreciated that user input may take different forms, such as answers to questions, selection of colors; text input etc. Some questions may refer to the action in the story, while other questions may define properties of the movie and/or of the characters therein. Presenting questions may enable selections from a user.

A script may be considered a set of rules of how to manage such resources and user input to produce a movie. It will be appreciated that a single script can produce a countless number of different movies according to the different resources and user input used.

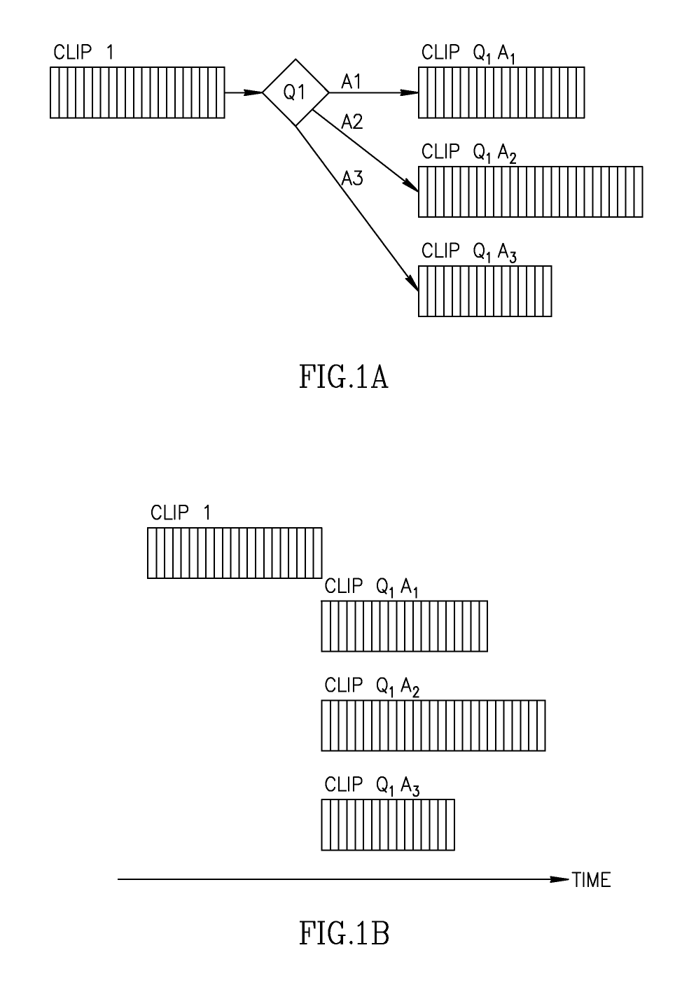

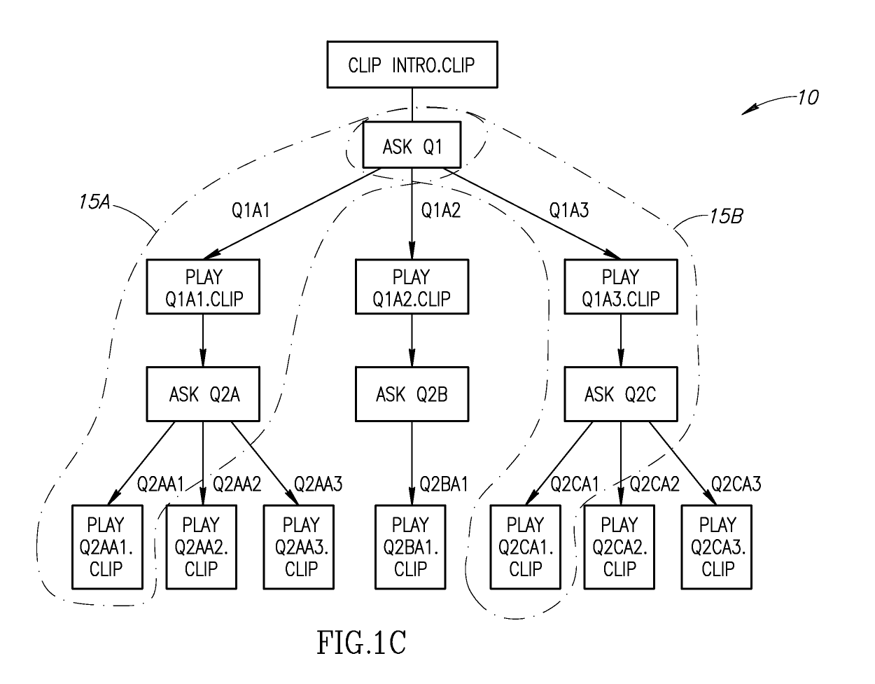

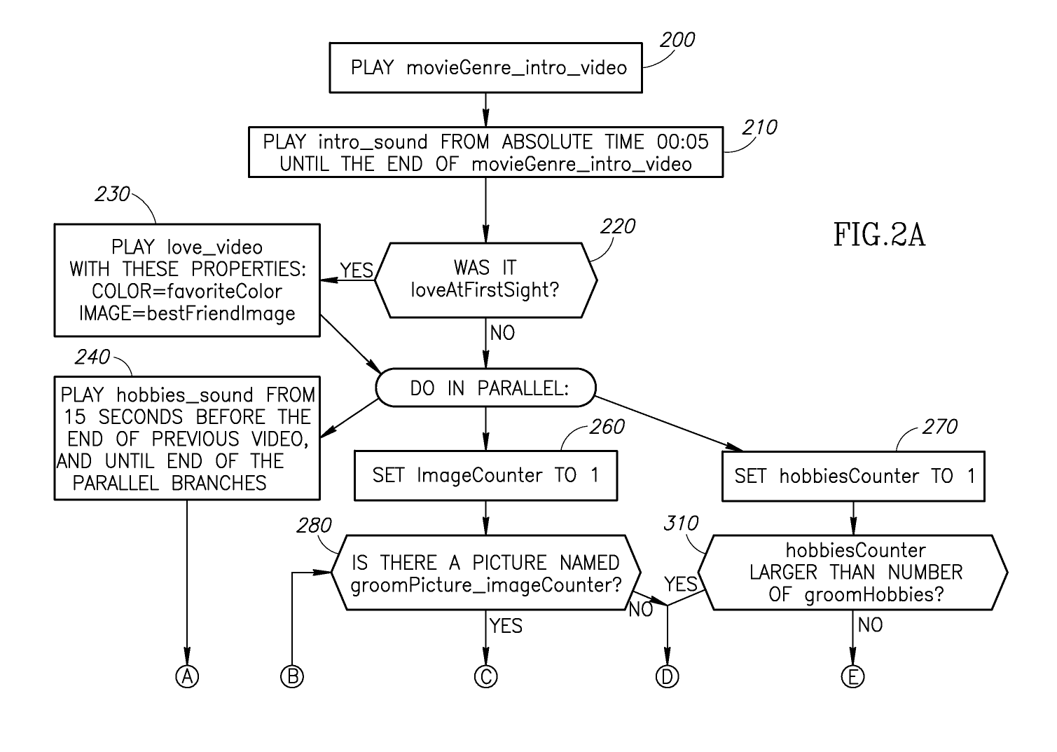

Reference is now made to FIG. 1A which illustrates a view of a simple generic script 10, used to determine the action/story line of a simple movie. It will be appreciated that this is an example only; the present invention incorporates much more complicated story lines and scripts.

Generic script 10 may begin by playing clip 1. When clip 1 has finished playing, user 5 may be asked a question Q1. Accordingly, the next clip to be played may depend on whatever answer is selected for question 1. For example, if answer 2 (A2) is selected, the next clip played may be clip Q1A2.clip. It will be appreciated that any clip that is selected after Q1 has been asked will start to play at the same time as illustrated in FIG. 1B which shows a simplified system view of how generic script 10 may be interpreted. Clip 1 may play for a time t. It will be appreciated that clips Q1A1, Q1A2 and Q1A3 (whichever is selected) may all automatically follow on from clip 1 at time t regardless of their length to ensure continuity regardless of the selected clip.

It will be further appreciated that each question may generate multiple possible answers and therefore multiple possible scenarios. For clarification of explanation, a simple generic script 10 (such as that described herein above) may be compared to a tree, of which a storyline 15A may be considered a branch, as illustrated in FIG. 1C to which reference is now made. It will be appreciated that a storyline 15 may evolve as more and more questions are asked and more and more clips are added to a resultant set of clips. For example, for script/tree 10, one possible storyline branch 15A may consist of playing the intro clip (intro.clip) followed by Q1A1.clip and then Q2AA1.clip. It will be further appreciated that a storyline 15B may also be generated from the same generic script 10 by playing the Q1A3.clip followed by Q2CA1.clip. It will also be appreciated that tree/script 10 may be also considered a large network of all possible permutations of scenarios for storylines such as 15A and 15B and that storylines 15A and 15B may be considered subsets of the possible permutations. It will also be further appreciated that within generic script 10, a question may lead to another question or a clip may follow on from another clip etc. It may also be appreciated that groups of pertinent questions and resultant clips may also be clustered together.

It will be appreciated that the examples provided in FIGS. 1A, 1B and 1C show a basic functionality of the concept of generic script 10 only. It will also be appreciated that storyline 15 may not only be a “linear” selection of questions and clips such as represented by the tree in FIG. 1C but may also be considered a large collection of answers and clips that may be generated according to user input, not necessarily following on from each other in a linear order. For example, one particular answer to a question may automatically generate a set of clips related to that answer.

It will be further appreciated that generic script 10 may be encoded in a proprietary XML-based language. The resulting program script 20 may contain the different permutations of clips as described herein above and may also provide additional functionality. For example, program script 20 may also include instructions for properties for dynamic resources within clips (described herein below) as well as definitions for user input items which are required to create the movie such as, for example, text for street signs within the movie. Program script 20 may also describe how to tailor the above mentioned resources into the finished movie. Program script 20 may be also pre-determined according to a particular theme such as a wedding theme and may contain scenarios for different genres (described in further detail herein below) within the same theme.

User input sources are any components which may provide resources and thus the properties required to tailor a movie in question, such as selection of a pertinent clip (as described hereinabove), defining properties of the characters within the movie (skin tone, clothing style, etc.), providing textual input etc. It will be appreciated that user input sources may be provided via a questionnaire with either free text or multiple choice answers and/or may be in the form of a different user interface such as a date picker for selecting a date etc. Other user input sources may also include a web interface for uploading photos, cropping them and styling them or an editor interface for editing text, fonts, color etc. It will be appreciated that all user input may be given a textual representation and may be assigned into variables to be used by program script 20. It will also be appreciated that some user input items may be mandatory for creating the movie. For example, a user 5 may be required to select a genre for a movie, answer where they were born, name their three favorite cities in the world and upload a photo of themselves.

Resources are any type of pre-prepared media that may be embedded in a video. These may include animation clips, video clips, sound clips, images, text, web links etc. There are two types of resources, static and dynamic. Static resources may be used “as is” (in part or as a whole), such as standard video clips and audio files. Dynamic resources are resources that may be modified by a set of external properties. An example of such a dynamic resource is a text field. A text field may be changed with text, color, font etc. Other dynamic resources may include visual elements, such as skin tone, to which effects may be applied (color, rotation etc.) and sound. It will be appreciated that video/animation clips may also contain external components, whose properties are not necessarily known in advance. An example of this is a FLASH clip which may allow for a later embedding of an external image, text or video in one of its internal components.

It will be appreciated that within program script 20 (as described hereinabove), different user input may generate different resources. For example, the same resources may be used for different components and/or the same components may use different resources. For example an answer to the question “what year were you born in?” may generate a set of clips pertinent to the birth year. Alternatively, the same clip may appear twice within program script 20, once with the property of a blue background and once with a green background.

Within the movie industry, a genre refers to types of film based on similarities in the narrative elements from which films are constructed. Films are usually categorized according to their setting, theme topic, mood, or format. It will be appreciated that a genre differs from a theme in that one theme may contain more than one genre. For example, for a wedding themed program script 20, a final movie may be created in a TV show genre, telling the story of how a couple met in the format of a chat show host telling the story. An alternative genre may be film noir, telling the story how a couple met through a black and white crime style movie. It will be appreciated that each genre script 20 may use identical clips and user input but display them differently from each other, or may use different clips with the same user input. It will be appreciated that in each case, once user 5 has provided his input, the input may be used to create any genre of movie within the same theme, without user 5 having to provide any additional input to do so.

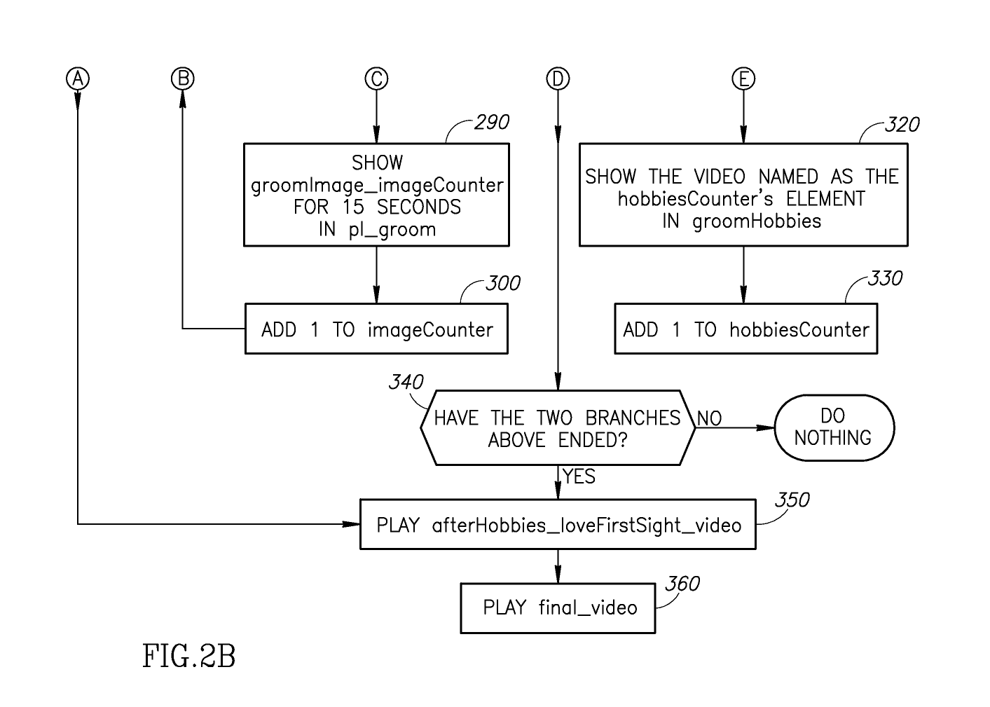

Reference is now made to FIGS. 2A and 2B which represent the functionality of an exemplary program script 20 for a wedding theme in accordance with a preferred embodiment of the present invention. Some of the questions requiring input from a user 5 may include questions such as, was it love at first sight? What are the bride's hobbies? What are the groom's hobbies? Etc. Each question may have multiple answers. It will be appreciated that any two storylines 15A, 15B created from the same program script 20 may tell different stories according to user input and according to genre if available. It will further be appreciated that certain inputs may be mandatory and that without them, program script 20 may not be able to continue.

Program script 20 may begin by playing an introductory video clip (200), play sound (210) starting from 5 seconds into the introductory clip and then ask the question whether it was love at first sight (220)? From this point, the storyline 15 being created may take two paths. If it was love at first sight between the bride and groom (storyline 15A) then a love video (230) may be played. Love video (230) may also be played with its color set to “favoriteColor” and with “bestfriendImage” used as its image. If a negative answer was provided to the question then storyline 15B is created and the love video (230) is skipped over. Program script 20, then plays sound clip hobbies_sound (240). It will be appreciated that in parallel to playing clip hobbies_sound (240), program script 20 may also require both the image counter (imageCounter) 260 and hobbies counter (hobbiesCounter) 270 to be set to 1. While sound clip hobbies_sound (240) continues to play, program script 20 may check whether there is a picture stored of the groom (280). If a positive answer is given, then program script 20 may go through all the available images of the groom and display each (290) for 15 seconds within placeholder pl-groom. This may be done in a cyclic procedure (loop) using image counter (260). As long as the image counter is smaller than the total number of groom images (280), the next groom image (290) is displayed for a further 15 seconds. The image counter is then incremented by 1 (300). It will be appreciated that in parallel to processes 280, 290 and 300, program script 20 may play the groom's hobby clips. If user 5 has entered multiple hobbies for the groom, the first clip relating to the first hobby is played (320). The hobbies counter then may be incremented by 1 (330). It will be appreciated that program script 20 will loop and play clips relating to all the groom's hobbies until the value of hobbies counter is greater than that of the groom's hobbies and there are no more hobbies to display. It will further be appreciated that processes 280, 290 and 300 may loop in conjunction with processes 310, 320, 330 providing an image of the groom until there are no more groom clips and no hobbies to display. When there are no more groom images and no more hobby clips to display (340), the afterHobbies_loveFirstSight_video (350) is played. Program script 20 ends by playing the final_video clip (360).

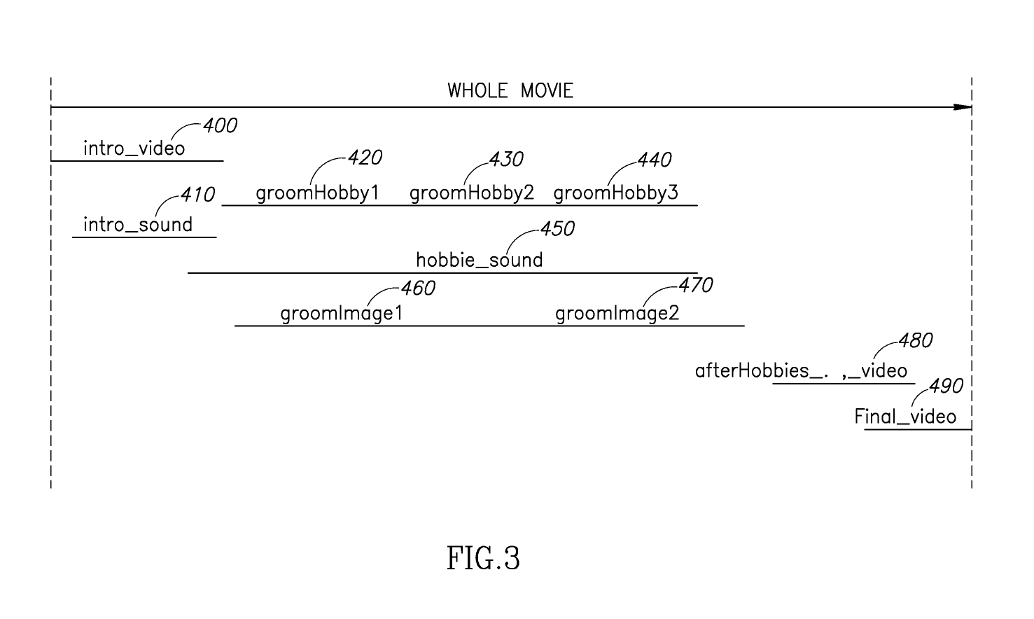

It will also be appreciated that the final output of program script 20 and resulting movie, may contain layered resources positioned over the timeline in arbitrary or pre-determined order and not necessarily in sequence. Reference is now made to FIG. 3 which illustrates such a timeline for a program script 20 similar to that described in FIGS. 2A and 2B. It will be appreciated, that each line represents a different resource taking part in the movie. First the intro_video (400) may be scheduled to start playing, followed by the intro_sound (410). While both the video and sound clips are still playing, the hobbies_sound clip (450) may also begin to play. This clip continues to play when both the intro_video (400) and intro_sound (410) clips stop and the groom hobby clips (in this example there are three) 420, 430, 440 start to play one after the other. It will be appreciated that while the hobby clips (420, 430, 440) are played, the groom image clips (460, 470) are shown. Once the groom hobby clips (420, 430, 440) have ended, the hobbies_sound clip (450) also ends and the last groom image (470) continues to be shown. Then the afterHobbies_video clip (480) is shown followed directly by the final_video clip (490).

It will further be appreciated that program script 20 may also create more than one storyline 15 at any one time. For example, for the wedding example discussed hereinabove, a storyline 15 concerning the groom growing up may be created concurrently with a storyline 15 concerning the bride growing up. Some of the questions asked may concern the groom and some the bride with the answers stored and used accordingly. Both storylines 15 may then be presented to user 5 either one after the other or simultaneously according to program script 20. Simultaneous presentation of storylines 15 may be performed using a split display, as discussed in more detail herein below.

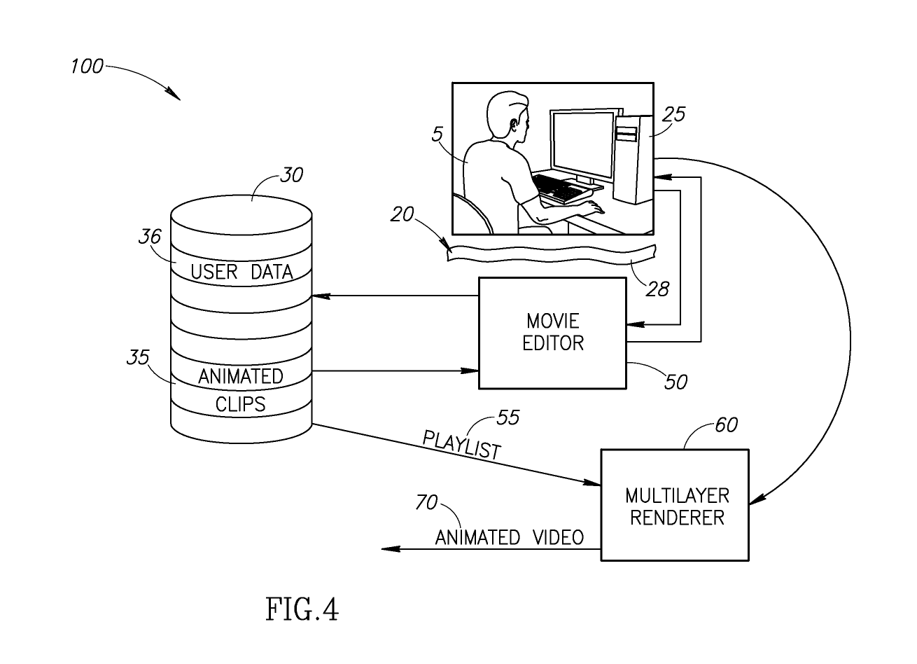

Reference is now made to FIG. 4, which illustrates a system 100 for generating and creating an animated video 70, such as described in FIGS. 1A, 1B, 1C, 2 and 3 prompted and controlled by user interaction and created in accordance with an embodiment of the current invention. System 100 may comprise a database 30 which may store pre prepared clips 35 and user data 36, a movie editor 50 and a multilayer renderer 60. It will be appreciated that system user 5 may access system 100 via internet 28. It will further be appreciated that an animated video is discussed as an example and that a non-animated video may be created in the same manner.

It will be appreciated that movie editor 50 may have multiple functionality and may provide the GUI (graphical user interface) between user 5 and system 100, functioning as a user input source. A user 5 sitting at a computer 25 may interact with movie editor 50. It will be appreciated that any suitable computing device with an internet connection may be used instead of computer 25 such as a smartphone, tablet etc. User 5 may select a pre-defined program script 20 from an initial menu of options, such as the wedding themed script described herein above. It will be further appreciated that there may be an option to pick a genre of film within the chosen theme. It will also be appreciated (as discussed herein above) that program script 20 may use a proprietary XML-based language and may include variables, loops, conditional expressions and sub-routine blocks as illustrated in FIG. 2. Program script 20 may not only define how to tailor the resultant movie, but may also define rules as to how to receive input from user 5. For example, program script 20 may define that all user input is acquired at the beginning and that user 5 is shown only the personalized resultant movie, or that the questions requiring input are spread throughout the timeline of program script 20, generating parts of the finished movie gradually, or a combination of the two. It will be appreciated that if the questions requiring input are spread throughout the timeline, user 5 may view each resultant clip as it is created.

It will also be appreciated that movie editor 50 not only gathers user data 36 from user input sources but may also assign variables to them (as described herein above). Movie editor 50 may also read and interpret program script 20, and may handle dynamic resources by resolving and applying required properties for each resource. For example, movie editor 50 may apply user-defined colors to relevant components, load external images and embed them in dynamic video clips. Movie editor 50 may also load the relevant resources and place them over a timeline (as described herein above). Movie editor 50 may also apply these variables to generate a list of resources to be used in animated video 70.

It will be further appreciated that movie editor 50 may not only act as a GUI and interpret program script 20, but may also be considered a player and may play to user 5 a resultant clip or a series of clips during its interpretation of program script 20. It will also be appreciated that in order to ensure continuity of clips 35, movie editor 50 may play clips 35 according to the timeline as defined in FIG. 3. It will be further appreciated that movie editor 30 may play to user 5 more than one series of clips simultaneously on a divided screen. For example the clips pertinent to the bride's childhood storyline 15 may be played on one side of the screen while the groom's is played on the other.

It will also be appreciated that at any time, if user 5 is dissatisfied with a resultant clip or the direction his storyline 15 is taking according to his input (for whatever method or type of input that was used), he may back track, re-enter his input and view the changed storyline 15. It will be further appreciated that in this way user 5 may change, at any time, the entire storyline 15 that is being created. For example, if user 5 decides that the bride and groom did not meet at a coffee shop as was originally entered, but instead met at college, the whole storyline 15 may take a different direction. It will also be appreciated, that since the creation of storyline 15 is not “linear’ (as is described here in above), user 5 may not automatically see any changes or updates to storyline. It will be appreciated that even a small change to the user data 36, such as the text used in a pertinent field used, may change several clips at different points during storyline 15. It will be further appreciated that if there is an option to pick a genre within a theme, program script 20 may play a pre-defined default genre until a different genre is chosen using a genre changer. It will also be appreciated that there may be an option to change the genre of the film within the chosen theme at any time, i.e. at the start, middle and end of program script 20.

It will be appreciated that by such a system selection of clips according to user input and by tailoring dynamic resources (as described herein above), there may be multiple ways to personalize animated video 70. It will be further appreciated that each pre prepared clip 35 may be created from FLASH clips (SWF) containing animation plus internal dynamic objects such as placeholders which, when given the appropriate properties can embed user text and adjust its size automatically to a specified area. Therefore (as an example) street signs, restaurant names and other labels may be personalized using text. For example, if the bride and groom both enjoy eating out at a particular restaurant, the pertinent pre prepared clip 35 played of the restaurant may show an animation or even a photograph of the pertinent restaurant complete with the real name displayed.

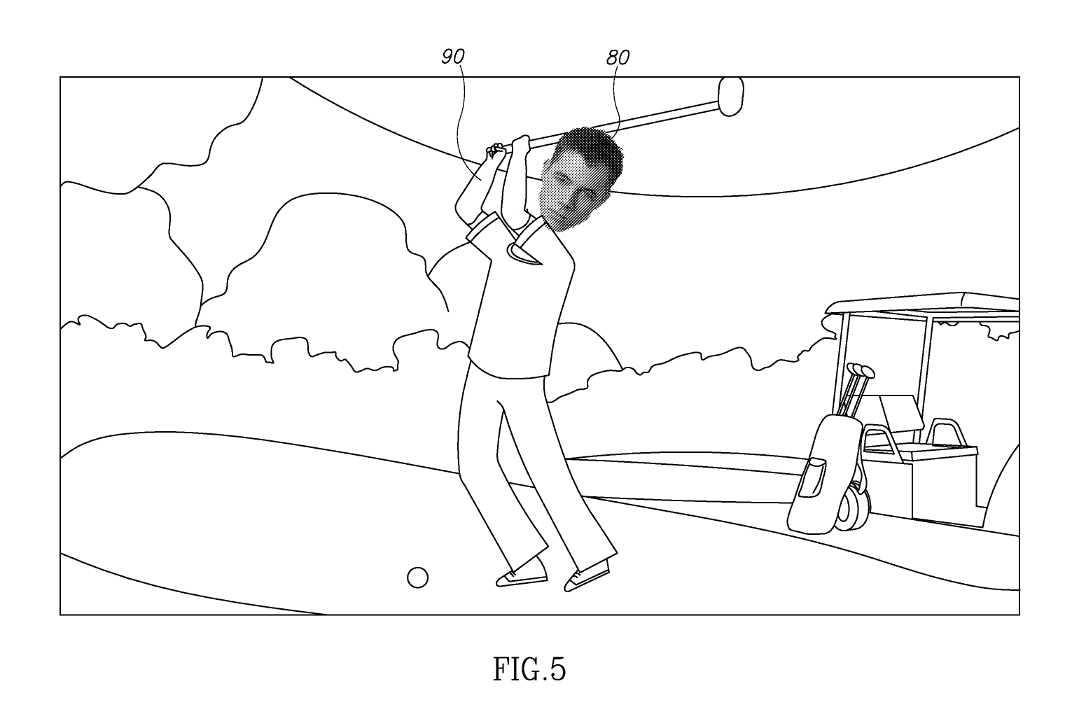

It will also be appreciated that the above mentioned SWF properties may also include embedding user images in a given placeholder. Reference is now made to FIG. 5 which illustrates a cartoon character with a human head 80 superimposed on it. It will be appreciated, in accordance with an embodiment of the present invention, that the characters of program script 20 may also be personalized as caricatures or as cartoon characters. For example, for the above mentioned wedding theme, both the animated bride and groom appearing in the clips may have their heads superimposed with photos of the heads of the real bride and groom for whom animated video 70 is being created. It will be appreciated that since movie editor 50 provides the GUI for user 5, it may also allow for user 5 to upload photographs of the real bride and groom. It will also be appreciated that in this manner animals and other inanimate objects such as a doll may also be personalized. Any suitable cropping tool may be used to prepare the photographs for the placeholders.

It will be further appreciated that the above mentioned SWF properties may also adjust the coloring and other properties of an internal component. For example, an animation of a moving character may comprise different objects representing different parts of its body. For example, as illustrated in FIG. 5, the represented cartoon character has nondescript “white arms” 90. Movie editor 50 may allow user 5 to choose the skin tone for the character in question from a list of pre-defined tones or may allow user 5 to define the color from a palette. Once chosen, the pertinent skin color may be stored in database 30 as a value for the skin tone property for the particular object representing the skin of the groom cartoon. In this way, other colors and/or shading in the animation may also be user selected.

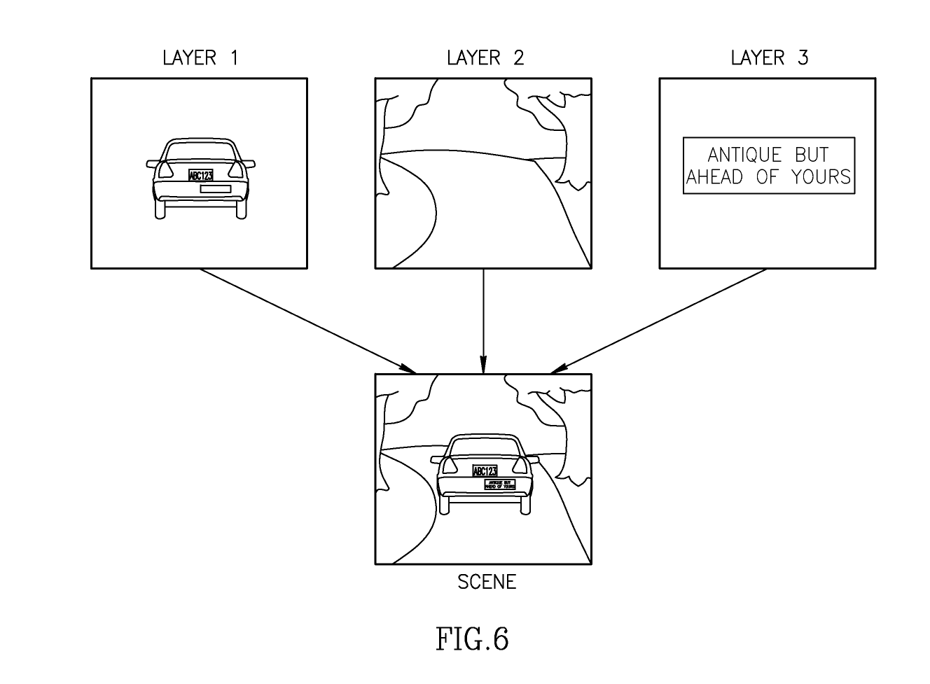

It will be further appreciated that the above mentioned SWF properties may also include applying a filter or layer to a whole clip, part of a clip, or an internal component in a clip. Certain video clips may be created by superimposing many different layers of scenes and that the different layers may also be selected by user 5 or as a result of user 5 input. For example user 5 may be asked which hobbies a bride has and one answer may be driving. User 5 may also be asked what color the bride's car is, where she likes to drive, if there is a bumper sticker on the car etc. Reference is now made to FIG. 6 which illustrates an instance of scene creation through layering. It will be appreciated that each layer may be pre-prepared and stored in database 30 and may be retrieved from database 30 by movie editor 50 according to user data 36. For the above mentioned example, layer 1 may be the active animation showing a red (user 5 given property) car in motion on a road. Layer 2 may provide the backdrop of where the car is driving such as a forest. Layer 3 may be text on the bumper sticker such as “Antique, but ahead of you”. It will be appreciated, that once superimposed on each other, layers 1, 2 and 3 may produce the scene of FIG. 5 with a red car driving against a forest backdrop while on the backend of the car there is a bumper sticker reading “Antique, but ahead of you”. Other files such as audio may be also added to the scene as additional layers.

It will be appreciated that as such movie editor 50 not only obtains input from user 5 and play clips 35 but may also interpret any object properties required in order to play clip 35 as defined by user 5 according to the pertinent program script 20. Movie editor 50 may handle dynamic resources by retrieving from database 30 and applying the necessary variable for each resource. For example, movie editor 50 may know the correct properties to present for objects such as car color and skin tone for a character as well as know how to present layers for a particular scene if required. Movie editor 50 may also interpret how to present clips on the time line of program script 20 and to allocate priority to overlapping clips if required.

Once movie editor 50 has finished interpreting program script 20, indicating that storyline 15 has been completed; movie editor 50 may assemble together a resultant clip set for storyline 15 together with relevant variables into a playlist 55 which may be stored in database 30. Movie editor 50 may then request approval of the resultant movie from user 5 via an appropriate interface. Once user 5 has approved the resultant movie, user 5 may then told to instruct multilayer renderer 60, via the pertinent interface to generate animated video 70 according to playlist 55. It will be appreciated that multilayer renderer 60 may be considered a “weakened version” of movie editor 50, whose only purpose is to convert the movie from FLASH format into a standard video format such as AVI or WMV. It will be appreciated that other video formats may also be used in order to create a 3D movie or holographic presentation etc. Renderer 60 may know which pre prepared clips 35 and user data 36 (i.e. playlist 55) to retrieve from database 30 but has no editing features and merely plays the finalized animated video 70 using a FLASH to video converter. It will also be appreciated, that the resulting animated video 70 cannot be modified in real time playback.

It will be further appreciated that in this way, a personalized animated or non-animated movie may be created where a user 5 may indirectly have control over the story line 15 and the ability to personalize different scenarios with text, music and caricatures etc. It will also be appreciated that although user 5 may control the direction his storyline 15 takes, user 5 is not required to perform any editing or provide extensive media input in order to create his animated personalized movie. Storyline 15 is ultimately created by system 100 using a subset of pre-prepared clips 35 selected and tailored using user data 36, according to program script 20. It will also be appreciated that countless different themes and genres may be used and that resulting movies may be created for both social and professional events.

In an alternative embodiment to the present invention, after the rendering, animated video 70 may be re-rendered within another genre, since no further user data 36 is required. Thus more versions of the movie may be created in additional genres.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description above. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for creating an animated and/or non-animated movie, the system implementable on a computing device, the system comprising:
a database to store at least one script and at least one modifiable, animated and/or non-animated clip; and
a movie editor to receive and store user input with which to build an modifiable movie following one of said at least one script and formed of selected ones of said clips using said user input, to enable said user to update any of said user input, to play said modifiable movie with said updated user input, and to create a playlist from said at least one script, said selected clips and at least one said user input.

2. The system according to claim 1 and wherein said movie editor comprises:
a user interface to present questions to and/or enable selections from a user according to a script and to receive said user input;
an interpreter to interpret said script according to said user input;
a coordinator to retrieve and save information in said database; and
an applier to apply said user input as variables to update said selected clips.

3. The system according to claim 1 and wherein said clips comprise objects having properties which are at least parametrizable with said user input.

4. The system according to claim 1 and wherein said clips comprise objects having properties which are at least personalizable with said user input.

5. The system according to claim 1 and wherein said user input is at least one of: a selection from a list, texts, images, sounds, colors, skin tone, video, and answers to questions.

6. The system according to claim 1 and wherein said script is a set of rules of how to manage said clips and said user input to produce said movie.

7. The system according to claim 1 and also comprising a renderer to render said movie according to said playlist.

8. The system according to claim 7 and wherein said clips comprise at least two layers of objects and said movie editor displays said at least two layers at least partially overlapped.

9. The system according to claim 8 and wherein said renderer renders said at least two layers at least partially overlapped.

10. The system according to claim 1 and wherein said movie editor comprises a player to play at least two clips on a divided screen when instructed by said playlist.

11. The system according to claim 1 and wherein said clips are defined as belonging to a genre.

12. The system according to claim 11 and also comprising a genre changer to generate a new playlist for said modifiable movie by selecting clips from said database belonging to a new said genre using said existing user input and to provide said modifiable movie in said new genre to said movie editor.

13. A system for creating an animated and/or non-animated movie, the system implementable on a computing device, the system comprising:
a database of parametrized clips; and
a movie editor to select ones of said clips according to said user input and to provide parameters for at least one of said clips according to said user input.

14. The system according to claim 13 and wherein said movie editor comprises:
a user interface to present questions to and/or enable selections from a user according to a script and to receive said user input;
an interpreter to interpret said script according to said user input;
a coordinator to retrieve and save information in said database; and
an applier to apply said user input as variables to update said clips.

15. The system according to claim 13 and wherein said clips comprise objects having properties which are at least parametrizable with said user input.

16. The system according to claim 13 and wherein said clips comprise objects having properties which are at least personalizable with said user input.

17. The system according to claim 13 and wherein said user input is at least one of: a selection from a list, texts, images, sounds, colors, skin tone, video, and answers to questions.

18. The system according to claim 13 and wherein said script is a set of rules of how to manage said clips and said user input to produce said movie.

19. The system according to claim 13 and also comprising a renderer to render said movie according to said playlist.

20. The system according to claim 19 and wherein said clips comprise at least two layers of objects and said movie editor displays said at least two layers at least partially overlapped.

21. The system according to claim 20 and wherein said renderer renders said at least two layers at least partially overlapped.

22. The system according to claim 13 and wherein said movie editor comprises a player to play at least two clips on a divided screen when instructed by said playlist.

23. The system according to claim 13 and wherein said clips are defined as belonging to a genre.

24. A method for personalizing an animated or/and non-animated movie, the method implementable on a computing device, the method comprising:
having at least one animated or/and non-animated clip, each said clip having at least one variable property;
receiving user input to personalize at least one of said at least one variable property; and
playing at least one of said animated or/and non-animated clips with said user input for said variable property.

25. The method according to claim 24 and also comprising:
presenting questions to and/or enabling selections from a user according to a script and receiving said user input;
interpreting a script according to said user input;
retrieving and saving information in a database; and
applying said user input as variables updating said clips and creating a playlist from said at least one script, said clips and at least one said user input.

26. The method according to claim 24 and wherein said clips comprise objects having properties which are at least parametrizable with said user input.

27. The method according to claim 24 and wherein said clips comprise objects having properties which are at least personalizable with said user input.

28. The method according to claim 24 and wherein said user input is at least one of: a selection from a list, texts, images, sounds, colors, skin tone, video, and answers to questions.

29. The method according to claim 24 and wherein a script is a set of rules of how to manage said clips and said user input to produce said movie.

30. The method according to claim 24 and also comprising rendering said movie according to said playlist.

31. The method according to claim 30 and wherein said clips comprise at least two layers of objects and said movie editor displays said at least two layers at least partially overlapped.

32. The method according to claim 31 and wherein rendering said at least two layers at least partially overlapped.

33. The method according to claim 24 and wherein said movie editor comprising and also playing at least two clips on a divided screen when instructed to by said playlist.

34. The method according to claim 24 and wherein said clips are defined as belonging to a genre.

35. The system according to claim 23 and also comprising a genre changer to generate a new playlist for said modifiable movie by selecting clips from said database belonging a new said genre using said existing user input and to provide said modifiable movie in said new genre to said movie editor.

36. The method according to claim 34 and also comprising a genre changer generating a new playlist for said modifiable movie by selecting clips from said database belonging a new said genre using said existing user input and to providing said modifiable movie in said new genre to said movie editor.

37. A method for creating an animated and/or non-animated movie, the method implementable on a computing device, the method comprising:
storing at least one script and at least one modifiable, animated and/or non-animated clip in a database;
receiving and storing user input with which to build a modifiable movie following one of said at least one script and formed of ones of said clips using said user input;
enabling said user to update any of said user input,
playing said modifiable movie with said updated user input; and
creating a playlist from said at least one script, said clips and at least one said user input.

38. A method for creating an animated and/or non-animated movie, the method is implementable on a computing device, the method comprising:
having a database of parametrized clips; and
selecting ones of said clips according to said user input; and
providing parameters for at least one of said clips according to said user input.

39. A system for personalizing an animated or/and non-animated movie, the system being implementable on a computing device, the system comprising:
a database storing at least one animated or/and non-animated clip, each said clip having at least one variable property;
a user interface to receive user input to personalize at least one of said at least one variable property; and
a player to play at least one of said animated or/and non-animated clips with said user input for said variable property.
